(19) United States
(12) Patent Application Publication
(10) Pub. No.: US 2009/0260292 A1
(43) Pub. Date: Oct. 22, 2009

(54) Door Drive Including a Spring Pre-Loading, which is Adjustable During the Movement of the Door

(75) Inventor: Holger Hansch, Witten (DE)

Correspondence Address: COHEN, PONTANI, LIEBERMAN & PAVANE LLP, 551 FIFTH AVENUE, SUITE 1210, NEW YORK, NY, 10176, US

(73) Assignee: DORMA GMBH + CO. KG, ENNEPETAL (DE)

(21) Appl. No.: 12/227,892

(22) PCT Filed: May 2, 2007
(86) PCT No.: PCT/EP2007/003836

§ 371 Date: Dec. 29, 2008

(30) Foreign Application Priority Data
Jun. 1, 2006 (DE) 10 2006 026 008.2

(51) Int. Cl. E05F 15/10

(52) U.S. Cl. 49/340; 49/358

(57) ABSTRACT

The invention relates to a door drive with a motor-gear-unit and with a spring (7), which acts as an energy accumulator. With the intention to provide a door drive, in which, through the exchange of a single structural component, two variants for scissor arm assemblies, respectively slide channel arm assemblies are realized, according to the invention, it is provided that the pre-loading of the spring (7) can be actively changed by the motor-gear-unit, whereby the desired closing moment characteristics are generated.

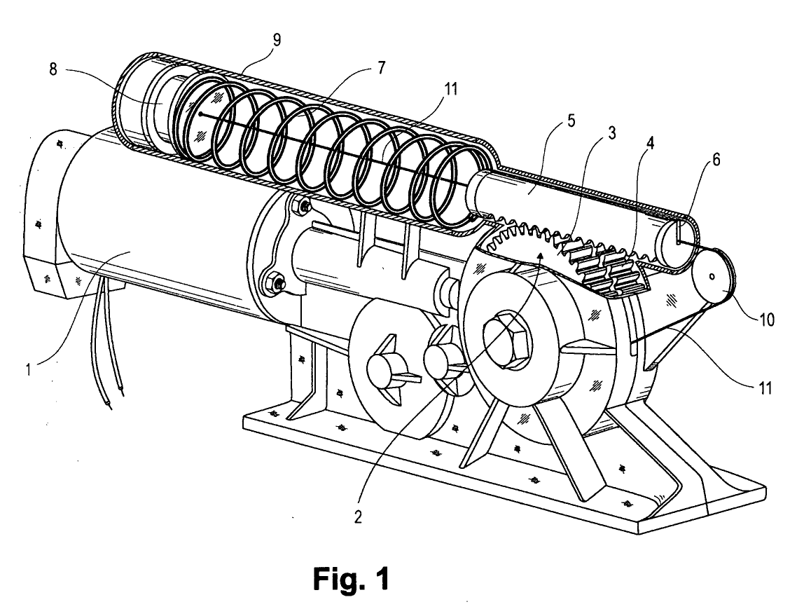

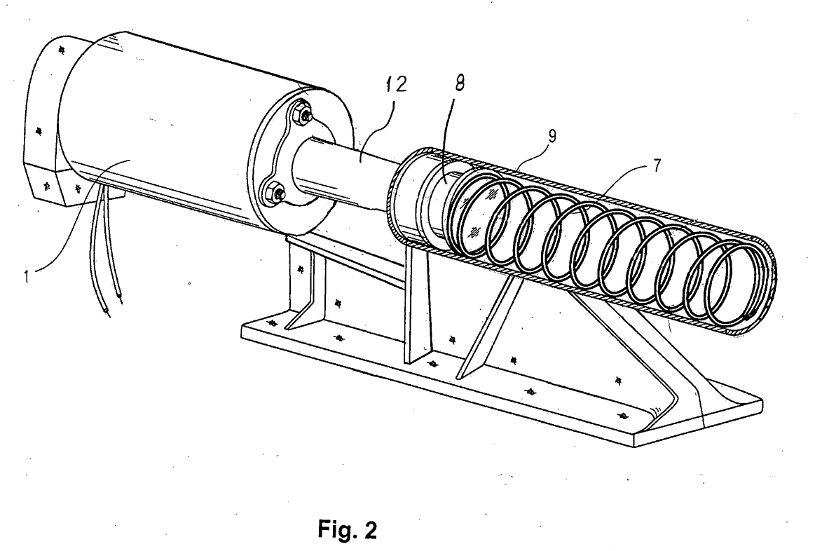

The invention relates to a door drive with a motor-gear-unit and with a spring, which acts as an energy accumulator.

With a swing leaf door drive there are basically two possibilities for the transmission of the driving power of the door drive onto the door leaf: a scissor arm assembly and a slide channel arm assembly, respectively, arrangements derived therefrom having comparable principles of action. Depending on the installation situation, it is recommended to use one or the other transmission mechanism. However, the momentum curve progressions at the door, required for the self-closure according to standards, call for different shaft momentum curve progressions changing over the door opening angle with each transmission mechanism, such that, depending on the transmission mechanism, different motor-gear-units need to be employed as well. This however causes high expenses in structural components and leads to creating a multitude of variants.

Therefore, it is the object of the present invention to provide a door drive, in which exchanging a single structural component creates two variants for scissor arm assemblies, respectively for slide channel arm assemblies. A maximum amount of equal components is thereby achieved.

This problem is solved through a door drive with a motor-gear-unit and with a spring, acting as an energy accumulator, wherein the pre-loading of the spring can be actively changed through the motor-gear-unit.

As a result of this embodiment, one and the same door drive can be employed for both transmission mechanism types. Depending on the selected transmission mechanism, just the pre-loading of the spring needs to be adapted correspondingly.

The dependant claims include advantageous further developments of the invention.

According to an advantageous further development, the spring bears against an abutment and the change of the pre-loading of the spring is made through changing the position of the abutment.

Advantageously, the motor-gear-unit has at least one toothed wheel meshing with a toothed rack.

According to a preferred embodiment, the toothed wheel consists of two parallel toothed discs and a hub disposed therebetween.

Advantageously, the hub has a contour that varies over the radius.

According to an advantageous configuration, the toothed rack has a slot extending in the longitudinal direction thereof.

According to an advantageous further development, a traction means is fastened to the hub, which means extends between the two toothed discs of the toothed wheel, through the slot in the toothed rack, and through the inside of the spring and is fastened to the abutment.

According to a preferred configuration, the structure is configured in that a rotation of the toothed wheel will cause a winding, respectively unwinding of the traction means, which in turn effects the adjustment of the abutment.

Furthermore, the traction means is advantageously guided via a return pulley, which is disposed between the hub and the toothed rack.

According to an advantageous further development, an additional transmission or reduction ratio can be an integral part of the return pulley, if necessary with a variable radius.

As an alternative to adjusting the abutment via a traction means, according to an advantageous configuration, a threaded spindle maybe disposed at the abutment, which spindle can be driven via the motor-gear-unit such that the abutment can be adjusted directly by the motor-gear-unit.

Further details, features and advantages of the invention will become apparent from the following description, reference being made to the drawing.

The sole FIGURE shows the basic structure of the inventive door drive.

The inventive electro-mechanically driven door drive has a motor 1, which is in operational connection with a toothed wheel 2. The toothed wheel 2 consists of two toothed discs 3, 4 which are parallel to each other and are connected to each other by means of a hub, which hub has a contour with a variable radius. Thus a slot is formed between the two toothed discs 3, 4.

The toothed wheel 2, respectively the two toothed discs 3, 4 are meshing with a toothed rack 5, which is provided with a slot 6 extending in the longitudinal direction.

The spring 7 is supported in a housing 9, which, in the illustrated exemplary embodiment, extends parallel with regard to the longitudinal axis of the motor 1.

Furthermore, a return pulley 10 is provided, which is disposed between the toothed wheel 2 and the toothed rack 5.

A traction means 11 is attached at the hub between the two toothed discs 3, 4, which means is guided in the slot between the two toothed discs 3, 4, extends thereafter over the return pulley 10, through the slot 6 in the toothed rack 5 and through the spring 7 and so far as to the abutment 8 and is attached to the latter.

An additional transmission or reduction ratio can be integral part of the return pulley 10.

By off-setting the centers of the toothed rack 5 and of the spring 7, if necessary, the slotting may be foregone, or with a variable radius.

The inventive door drive is designed for the use with either a scissor arm assembly or with a slide channel arm. The torque characteristics are modified through a change of the pre-loading of the spring 7 effected by the motor 1. In the illustrated exemplary embodiment, this is realized through a rotation of the toothed wheel 2, whereby the traction means 11 is wound onto, respectively unwound from a hub having a variable diameter, whereby the abutment 8 of the spring 7 is adjusted. Thus the pre-loading of the spring 7 is likewise changed. On account of the contour of the hub, that has a variable radius, the torque characteristics can be controlled and adapted to the respective transmission mechanism (scissor arm assembly or slide channel arm). Thus these drive variants exclusively differ through the employed hub with the corresponding contour.

Instead of the above described procedure, the pre-loading of the spring 7 can be changed via a toothed wheel that is integral of the gear, via the output shaft of the door drive that is connected to a closer shaft, or through a spring abutment disposed on a threaded spindle, the drive thereof being effected via the motor 1 or via a gear shaft. However, on account of the fixed coupling between motor rotation and spring adjustment, it is not possible to create variants with the above configuration.

List of reference numerals

| | |
|---|---|
| 1 | motor |
| 2 | toothed wheel |
| 3 | toothed disc |
| 4 | toothed disc |
| 5 | toothed rack |
| 6 | slot |
| 7 | spring |
| 8 | abutment |
| 9 | housing |
| 10 | return pulley |
| 11 | traction means |

1. A door drive comprising:
a motor-gear-unit; and
a spring acting as an energy accumulator,
wherein pre-loading of the spring is actively changeable through activation of the motor-gear-unit.

2. The door drive according to claim 1, further comprising an abutment, wherein the spring bears against the abutment and of the pre-loading of the spring is changeable through a change of a position of the abutment.

3. The door drive according to claim 1, wherein the motor-gear-unit has at least one toothed wheel and a toothed rack which meshes with the toothed wheel.

4. The door drive according to claim 3, wherein the toothed wheel comprises two parallel toothed discs and a hub disposed therebetween.

5. The door drive according to claim 4, wherein the hub has a contour with a variable radius.

6. The door drive according to claim 3, wherein the toothed rack has a slot extending in a longitudinal direction of the toothed rack.

7. The door drive according to claim 6, further comprising a traction means fastened to the hub, wherein the traction means extends between the two toothed discs of the toothed wheel, through the slot in the toothed rack and through an inside of the spring and is fastened to the abutment.

8. The door drive according to claim 7, wherein a rotation of the toothed wheel effects winding, or unwinding of the traction means, whereby an adjustment of the abutment is realized.

9. The door drive according to claim 7, further comprising a return pulley disposed between the hub and the toothed rack, wherein the traction means is guided by the return pulley.

10. The door drive according to claim 9, wherein an additional transmission or reduction ratio is an integral part of the return pulley.

11. The door drive according to claim 1, further comprising a threaded spindle disposed at the abutment, wherein the threaded spindle is adapted to be driven via the motor-gear-unit.

12. The door drive according to claim 2, wherein the motor-gear-unit has at least one toothed wheel and a toothed rack which meshes with the toothed wheel.

13. The door drive according to claim 4, wherein the toothed rack has a slot extending in a longitudinal direction of the toothed rack.

14. The door drive according to claim 5, wherein the toothed rack has a slot extending in a longitudinal direction of the toothed rack.

15. The door drive according to claim 2, further comprising a threaded spindle disposed at the abutment, wherein the threaded spindle is adapted to be driven via the motor-gear-unit.

16. A door drive, comprising:
a motor gear unit;
an adjustable abutment;
a toothed rack;
an energy accumulator extending in a longitudinal direction and having one end supported on the abutment and another end supported on the toothed rack;
wherein the motor gear unit is operatively connected to the abutment and the toothed rack such that the motor gear unit is actuatable to move both the abutment and the toothed rack in a direction parallel to the longitudinal direction of the energy accumulator to change the pre-loading of the energy accumulator.
